(19) United States
(12) Patent Application Publication
(10) Pub. No.: US 2006/0229795 A1
(43) Pub. Date: Oct. 12, 2006

(54) Method for the diagnosis of driver outputs and diagnosis pulse manager

(75) Inventors: Andreas Laufer, Regensburg (DE); Konstantin Thiveos, Murnau (DE)

Correspondence Address: LERNER GREENBERG STEMER LLP, P O BOX 2480, HOLLYWOOD, FL, 33022-2480, US

(73) Assignee: SIEMENS AKTENGESELLSCHAFT

(21) Appl. No.: 10/566,561

(22) PCT Filed: Jul. 19, 2004
(86) PCT No.: PCT/EP04/51541

§ 371 Date: Feb. 21, 2006

(30) Foreign Application Priority Data
Jul. 31, 2003 (DE) 103 35 135.3

(51) Int. Cl. G06F 19/00

(52) U.S. Cl. 701/114

(57) ABSTRACT

The invention relates to a method for the diagnosis of driver outputs (20) and to a diagnosis pulse manager (10) that can supply a pulse to a driver output (20) in order to carry out a diagnosis of said driver output. As a plurality of diagnosis pulses may be required simultaneously for the system requirements (12), a diagnosis pulse requirement register (14) and a diagnosis pulse execution register (16) are provided such that a plurality of simultaneous requirements (12) can be stored. On the basis of the buffering of requirements (12), a plurality of stored pulse requirements can be successively taken into account according to pre-determined rules.

The invention relates to a method for diagnosis of driver outputs, especially for use in a motor vehicle, in which, for reading out a diagnosis result at a driver output, a pulse is fed to the driver output.

The invention further relates to a diagnosis pulse manager for feeding pulses to driver outputs depending on system requirements, especially for use in a motor vehicle to read out diagnosis results at driver outputs.

The monitoring of final stage driver outputs within the context of an error diagnosis during operation of a motor vehicle is known. To obtain clear diagnosis results in certain switching states it is necessary to actively feed a pulse to a final stage driver output. The system requests the supply of such a pulse.

In this context it is problematic, if a pulse requirement is present for a plurality of driver outputs simultaneously, especially if, for system reasons, a pulse cannot be provided simultaneously for all driver outputs. This is the case for example when the system only makes one timer functionality available.

The object of the invention is to provide a method and a diagnosis pulse manager, so that when pulses are required simultaneously for a number of driver outputs, a reliable error diagnosis can be undertaken.

This object is achieved with the features of the independent claims.

Advantageous embodiments of the invention are specified in the dependent claims.

The invention builds on the generic method by enabling an existing requirement of a pulse for a driver output to be stored, with especially a plurality of simultaneously existing requirements able to be stored, and by enabling a number of stored requirements to be taken into consideration successively according to predetermined rules. This means that if there are a plurality of requirements for pulses it is not necessary only to explicitly take account of one of these requirements and to discard the other requirements. Instead the requirements can be stored and taken into account in turn in accordance with predetermined rules.

The method is advantageously developed by the requirements being able to be stored as binary values in a diagnosis pulse requirement register, by the requirements stored in the diagnosis pulse requirement register being able to be transmitted to a diagnosis pulse execution register and by the diagnosis pulse requirement register being cleared after the requirements have been transmitted into the diagnosis pulse execution register. The system requirements can thus be stored initially in a diagnosis pulse requirement register and then, depending on processes in the past or on other criteria respectively, be transferred into a diagnosis pulse execution register. After transfer of the information the diagnosis pulse requirement register can be erased in order to enable new system requirements to be taken into consideration in the next cycle.

Usefully there is provision for the requirements only to be transferred from the diagnosis pulse requirement register to the diagnosis pulse execution register if no requirements are stored in the diagnosis pulse execution register. Otherwise a requirement stored in the diagnosis pulse execution register which is the next to be executed, is first converted into a pulse to be executed at the assigned driver output.

Furthermore it is useful, before the transmission of the requirements from the diagnosis pulse requirement register into the diagnosis pulse execution register, to delete from the diagnosis pulse requirement register requirements that are also no longer stored in the diagnosis pulse execution register. This takes account of whether conditions which might have obtained at one point in the past continue to obtain; Only if this is the case does the question of execution of the pulses at the corresponding driver output arise.

The invention is advantageously developed in that, after a requirement stored in the diagnosis pulse execution register is taken into account, this request is deleted in the diagnosis pulse execution register. This means that, for a subsequent request of the diagnosis pulse execution register, diagnosis pulses assigned to other driver outputs can be executed, provided corresponding requirements are stored in the diagnosis pulse execution register.

It is preferred that the predetermined rules are based on at least one of the following criteria: Different driver outputs have a different priority, and a request assigned to a specific driver output may be taken into account or not. Where different priorities are taken into account the requirements assigned to the higher-priority driver outputs are considered first. For example there can be provision for the driver channels to be prioritized in the order of their ordinal number. In the case of the other criterion as to whether a requirement assigned to a specific driver output may be taken into account or not, there can be provision, depending on other conditions, for entirely excluding required pulses from being applied to specific driver outputs.

Usefully there is provision for the priorities of the driver outputs to be defined by configuration of a control and prioritization unit. This can for example influence whether positions in the registers are actually to be written or deleted.

It is especially of advantage for the priorities of the driver outputs to change dynamically depending on the operating states of the motor vehicle. For example the evaluation of specific driver outputs can be especially useful at high speeds, said outputs only being of secondary interest on the other hand at lower speeds.

The invention builds on the generic diagnosis pulse manager by providing a diagnosis pulse requirement register for storing a requirement of a pulse which is present for a driver output, with especially a plurality of simultaneously existing requirements able to be stored, and by enabling a plurality of stored requirements to be successively taken into account according to predetermined rules. In this way the advantages and special features of the method in accordance with the invention can also be implemented within the framework of a diagnosis pulse manager. This then also applies to the especially preferred embodiments of the inventive diagnosis pulse requirement manager specified below.

This is developed in a useful manner by the requirements in the diagnosis pulse requirement register being able to be stored as binary values, by the requirements stored in the diagnosis pulse requirement register being able to be transmitted into a diagnosis pulse execution register and the diagnosis pulse requirement register being erased after transfer of the requirements into the diagnosis pulse execution register.

Furthermore there is provision for the requirements only to be transferred from the diagnosis pulse requirement register into the diagnosis pulse execution register if no requirements are stored in the diagnosis pulse execution register.

It is especially of advantage that, before the transmission of the requirements from the diagnosis pulse requirement register into the diagnosis pulse execution register, requirements no longer stored in the diagnosis pulse requirement register are also deleted in the diagnosis pulse execution register.

Preferably there is also provision, after a requirement stored in the diagnosis pulse execution register has been taken into account, for this requirement to be deleted in the diagnosis pulse execution register.

With the diagnosis pulse manager it is especially preferred that the predetermined rules are based on at least one of the following criteria: Different driver outputs have a different priority, and a requirement assigned to a specific driver output may be taken into account or not.

In this case there is also provision for the priorities of the driver outputs to be defined by configuration of a control and prioritization unit.

The inventive diagnosis pulse manager is advantageously developed by the priorities of the driver outputs being able to change dynamically depending on the operating states of the motor vehicle.

The invention is based on the knowledge that it is possible to ensure for simultaneous requirement of pulses for a plurality of driver outputs that all pulse requirements can be processed in a diagnosis pulse manager. In particular priority rules and control algorithms can be taken into account in this case.

The invention is now explained with reference to the accompanying drawings on the basis of preferred embodiments.

The drawings show:

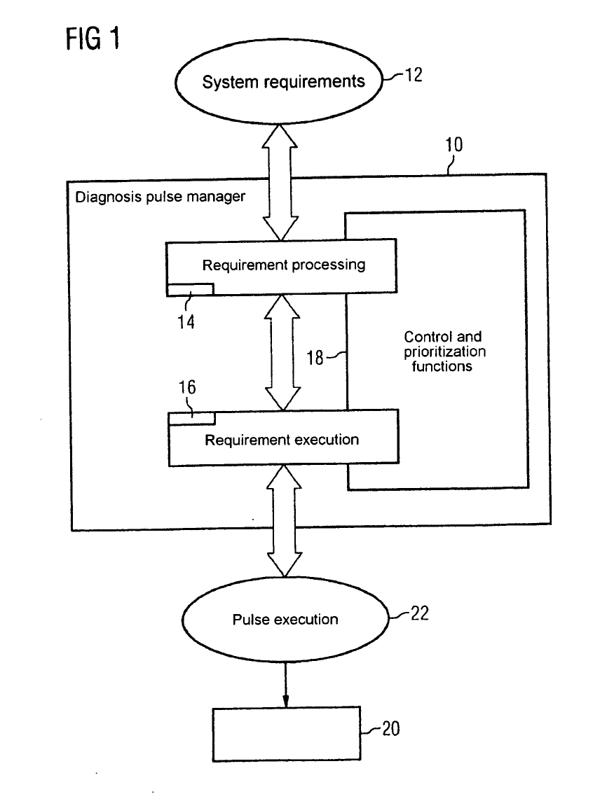

FIG. 1 a function block diagram to explain the present invention;

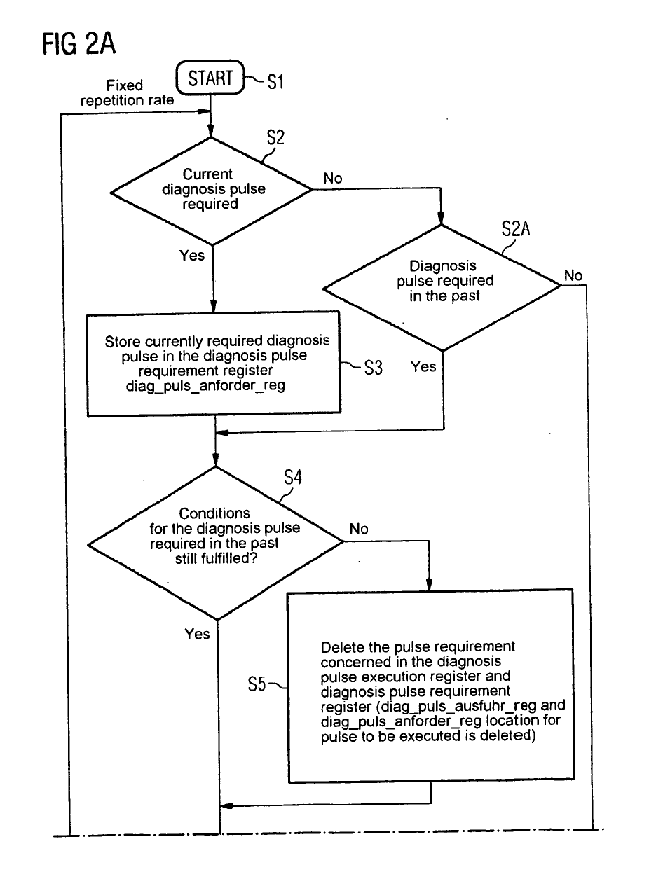

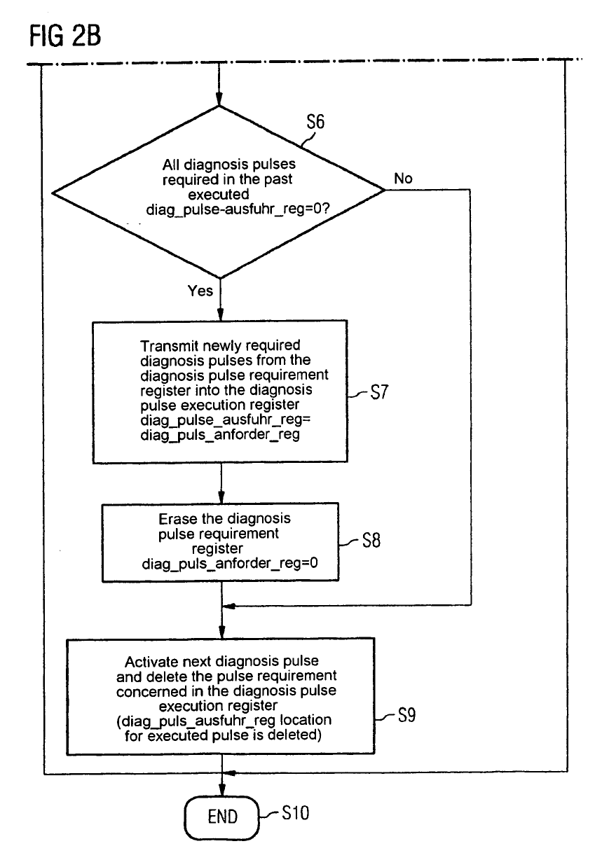

FIG. 2 a flowchart to explain the inventive procedure; and

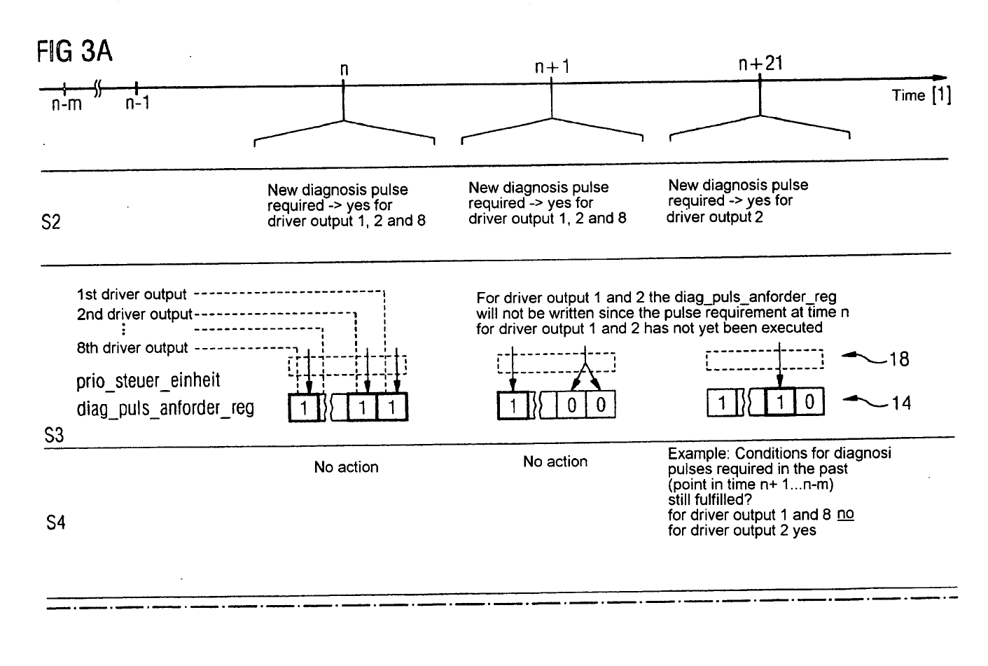

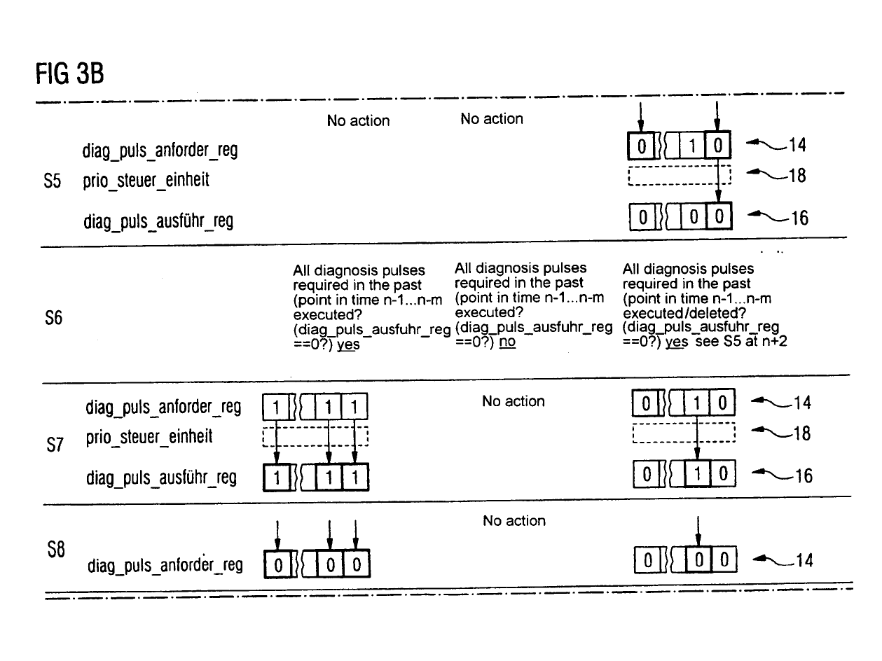

FIG. 3 a diagram for explaining the flowchart shown in FIG. 2 on the basis of a diagram.

FIG. 1 shows a function block diagram to explain the present invention. The central element shown in FIG. 1 is a diagnosis pulse manager 10. This is confronted on one side with system requirements 12 and must on the other side take care of a pulse execution 22 which relates to different driver outputs 20. The diagnosis pulse manager 10 performs these tasks by requirement processing, which especially includes a diagnosis pulse requirement register 14, and execution processing which especially includes a diagnosis pulse execution register 16. Information is passed between requirement processing and execution processing by control and prioritization functions 18, so that there is a guarantee that attention is paid to the system requirements 12 in pulse execution 22, especially taking into account different criteria, a process which will be explained below with reference to different examples.

FIG. 2 shows a flowchart to explain the inventive method. A general execution sequence of the method in accordance with the invention is first explained which occurs after the start of the method in step S1 with a fixed repetition rate. In step S2 a check is performed as to whether diagnosis pulses are currently required. If this is not the case, a check is performed in step S2A as to whether diagnosis pulses have been required in the past. If this is not the case either, the execution sequence of the method returns to checking as defined in step S2. If however diagnosis pulses have been required in the past, the execution sequence goes from step S2A to step S4 which in the case in which diagnosis pulses are currently required (step S2), is reached via the step S3. In this step S3 the currently required diagnosis pulse is stored in the diagnosis pulse requirement register “diag_puls_anforder_reg”.

In step S4 a check is now performed as to whether the conditions for diagnosis pulses required in the past continue to be fulfilled. If this is not the case, in accordance with step S5 the pulse requirement concerned is deleted in the diagnosis pulse execution register “diag_puls_ausführ_reg” and in the diagnosis pulse requirement register. After this, or if the conditions for the diagnosis pulse required in the past respectively continue to be fulfilled however, a check is performed in step S6 as to whether all diagnosis pulses required in the past are already executed, meaning whether the following applies for the diagnosis pulse execution register: diag_puls_ausführ_reg==0. If this is the case, in step S7 newly required diagnosis pulses are transmitted from the diagnosis pulse requirement register into the diagnosis pulse execution register, meaning that the diagnosis pulse requirement register is copied into the diagnosis pulse execution register (diag_puls_ausführ_reg=diag_puls_anforder_reg). Subsequently in step S8 the diagnosis pulse requirement register is erased (diag_puls_anforder_reg=0).

Subsequently in step S9 the next diagnosis pulse is activated and in the diagnosis pulse execution register the pulse requirement concerned is deleted. Step S9 can also be reached directly, starting from step S6, if not all diagnosis pulses required in the past are already executed. In this case the next diagnosis pulse is activated and the corresponding location in the diagnosis pulse execution register is erased for the diagnosis pulses required in the past. After step S9 the functional sequence returns to step S2 or ends at step S10 respectively.

FIG. 3 shows a diagram to explain the flowchart shown in FIG. 2 on the basis of an example. Different executions sequence for different scenarios or system requirements are explained with reference to this diagram In step S2, at point in time n, new diagnosis pulses are required, namely for the driver outputs 1, 2 and 8. Consequently the question asked in step S2 in accordance with FIG. 2 is answered with “yes” and the execution sequence goes to step S3.

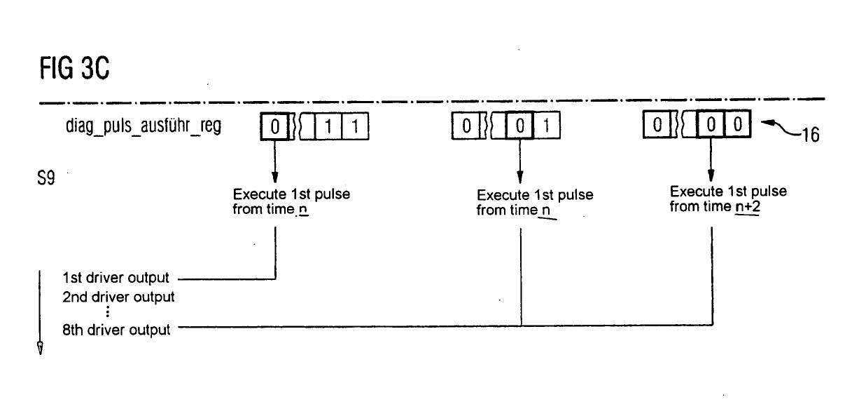

In step S3, through the mediation the prioritization and control unit, the currently required pulse is stored in the diagnosis pulse requirement register. In the case shown in the example the register locations 1, 2 and 8 are thus set to the value 1 with the active setting of the register locations in the diagram shown in accordance with FIG. 8 being identified by these register locations being shaded.

Subsequently in step S4, the question is asked whether the conditions for diagnosis pulses which may have been required in the past continue to be fulfilled. Since in the present example there are no diagnosis pulses which were required in the past, the answer to the question should be “yes” so that the method moves to step S6 from step S5 without taking any action. Step S6 then checks whether the following applies: diag_puls_ausführ_reg==0. In the case in which diagnosis pulses have already been required in the past, this means that these have also already been executed. In the example shown here the diagnosis pulse execution register is fully in state 0, since this is its initial state. The question in accordance with step S6 is thus answered with a “yes” so that in step S7 the newly required diagnosis pulses can be transferred from the diagnosis pulse requirement register to the diagnosis pulse execution register. This is done under the mediation of the prioritization and control unit.

Subsequently in step S8 the diagnosis pulse requirement register is erased.

In step S9 the next diagnosis pulse is activated and the corresponding pulse requirement is deleted in the diagnosis pulse execution register. In the present example the location in the diagnosis pulse execution register with the highest priority is the location which is assigned to the driver output with the highest ordinal number.

The execution sequence of the method then returns to step S2 in order to react to the system requirements present at point in time n+1. In the present example new diagnosis pulses are again required, namely here again for the driver outputs 1, 2 and 8. The question in step S2 is thus answered with “yes” and the execution sequence of the method goes to step S3. Since the value for the driver output 8 in the diagnosis pulse execution register at point in time n was set in step S9 to 0, this value is set in step n+1 back to 1 by contrast with the locations corresponding to the driver outputs 1 and 2 in the diagnosis pulse request register, since these are still set to 1 in the diagnosis pulse execution register.

In step S4 a check is subsequently made as to whether the conditions for diagnosis pulses required in the past continue to be fulfilled. Since this is the case—diagnosis pulses continue to be required for the driver outputs 1, 2 and 8—the execution sequence immediately goes to step S6 in which a check is made as to whether all the diagnosis pulses required in the past have been executed. This question is answered at point in time n+1 with “no” since the diagnosis pulses required for the first driver output and the second driver output have not yet been executed. The method consequently goes to step S9 where the next diagnosis pulse in the priority sequence is executed, namely the diagnosis pulse for the second driver output.

The method subsequently returns to step S2 where a check is performed as to whether diagnosis pulses are currently required. This question is answered with “yes” since at point in time n+2 a diagnosis pulse is required for driver output 2. Subsequently in step S3 the currently required diagnosis pulse is stored at the corresponding location in the diagnosis pulse requirement register.

Subsequently in step S4 a check is performed as to whether the conditions for diagnosis pulses required in the past continue to be fulfilled. This is only partly the case, namely for driver output 2 and not for driver outputs 1 and 8, so that the question must be answered with “no” overall. Subsequently the execution sequence of the method goes to step S5 where the corresponding locations are deleted in the diagnosis pulse execution register and in the diagnosis pulse requirement register. This relates in the diagnosis pulse requirement register to the locations 1 and 8 while in the diagnosis pulse execution register, because of the pulse execution already undertaken at the eighth driver output, only the location which corresponds to the first driver output will have to be set to 0.

In step S6 a check is performed as to whether all diagnosis pulses required in the past have been executed. This is the case since the diagnosis pulse execution register is completely set to 0. The method subsequently goes to step S7 and the state of the diagnosis pulse requirement register is transferred to the diagnosis pulse execution register.

Subsequently in step S8 the diagnosis pulse requirement register is erased.

in step S9 the only pulse to be executed in accordance with the diagnosis pulse execution register is executed for the second driver output and the corresponding location in the diagnosis pulse execution register is deleted.

Without this always having been pointed out above, the modifications in the registers are frequently undertaken under the mediation the prioritization and control unit, a fact which is indicated in the diagram shown in FIG. 3 by the arrows representing the influencing of the register locations having to pass through the boxes identified by a broken line symbolizing the prioritization and control unit 18.

Thus the invention can be summarized as follows: A method is specified for diagnosis of a driver outputs 20 and a diagnosis pulse manager 10 which are able to feed to a driver output 20 a pulse in order to perform a diagnosis of this driver output. Since the system requirements 12 and can turn out so that simultaneously a plurality of diagnosis pulses are required, a diagnosis pulse requirement register 14 and a diagnosis pulse execution register 15 are provided so that the plurality of requirements existing simultaneously 12 can be stored. On the basis of this buffering of requirements 12 it is possible for a number of stored pulse requirements to be taken into consideration successively in accordance with predetermined rules.

1-16. (canceled)

17. In a method of diagnosing a driver output, wherein a pulse is fed to the driver output for the purpose of reading out a diagnosis result at the driver output, the improvement which comprises:
storing a requirement of a pulse existing for the driver output;
successively taking into account a plurality of stored requirements in accordance with predetermined rules.

18. The method according to claim 17, which comprises storing a plurality of simultaneously existing requirements.

19. The method according to claim 17, wherein the driver is installed in a motor vehicle.

20. The method according to claim 17, which comprises:
storing the requirements in a diagnosis pulse requirement register as binary values;
transmitting the requirements stored in the diagnosis pulse requirement register into a diagnosis pulse execution register; and
selectively erasing the diagnosis pulse requirement register after the transmission of the requirements into the diagnosis pulse execution register.

21. The method according to claim 20, which comprises transmitting the requirements from the diagnosis pulse requirement register into the diagnosis pulse execution register only if no requirements are stored in the diagnosis pulse execution register.

22. The method according to claim 20, which comprises: prior to transmitting the requirements from the diagnosis pulse requirement register into the diagnosis pulse execution register, deleting the requirements which are no longer stored in the diagnosis pulse requirement register from the diagnosis pulse execution register.

23. The method according to claim 20, which comprises, after a given requirement stored in the diagnosis pulse execution register has been taken into account, deleting the given requirement from the diagnosis pulse execution register.

24. The method according to claim 17, wherein the predetermined rules are based on at least one of the following criteria:
different driver outputs have a different priority; and
a requirement assigned to a specific driver output may be taken into consideration or not.

25. The method according to claim 24, which comprises defining the priorities of the driver outputs by configuration of a control and prioritization unit.

26. The method according to claim 24, which comprises dynamically adapting the priorities of the driver outputs in accordance with operating states of the motor vehicle.

27. A diagnosis pulse manager for feeding pulses to driver outputs in dependence on system requirements, for the purpose of reading out diagnosis results at driver outputs, the pulse manager comprising:
a diagnosis pulse requirement register for storing an existing requirement of a pulse for a driver output; and
wherein a plurality of stored requirements are able to be taken into account successively in accordance with predetermined rules.

28. The diagnosis pulse manager according to claim 27, wherein said diagnosis pulse requirement register is configured to store a plurality of simultaneously existing requirements.

29. The diagnosis pulse manager according to claim 27 configured for drivers in a motor vehicle.

30. The diagnosis pulse manager according to claim 27, wherein:
said wherein diagnosis pulse requirement register is configured to store the requirements as binary values;
a diagnosis pulse execution register is connected to receive the requirements stored in said diagnosis pulse requirement register; and
said diagnosis pulse requirement register is erased after the requirements have been transferred into said diagnosis pulse execution register.

31. The diagnosis pulse manager according to claim 30, wherein the requirements are transmitted from said diagnosis pulse requirement register into said diagnosis pulse execution register only if no requirements are stored in said diagnosis pulse execution register.

32. The diagnosis pulse manager according to claim 30, wherein, before the requirements are transmitted from said diagnosis pulse requirement register into said diagnosis pulse execution register, requirements that are no longer stored in said diagnosis pulse requirement register are also deleted from said diagnosis pulse execution register.

33. The diagnosis pulse manager according to claim 27, wherein, after a requirement stored in said diagnosis pulse execution register has been taken into account, the requirement is deleted in said diagnosis pulse execution register.

34. The diagnosis pulse manager according to claim 27, wherein the predetermined rules are based on at least one of the following criteria:
different driver outputs have a different priority; and
a requirement assigned to a specific driver output may or may not be taken into consideration.

35. The diagnosis pulse manager according to claim 34, which further comprises a control and prioritization unit configured to define the priorities of the driver outputs.

36. The diagnosis pulse manager according to claim 34, wherein the priorities of the driver outputs are subject to dynamic change in dependence on operating states of the motor vehicle.
